(19) United States
(12) Patent Application Publication
(10) Pub. No.: US 2016/0130777 A1
(43) Pub. Date: May 12, 2016

(54) Method of and driver for installing foundation elements in a ground formation

(71) Applicant: HIC HOLLAND IE B.V., Sliedrecht (NL)

(72) Inventor: Justin Edward Stam, Amsterdam (NL)

(21) Appl. No.: 14/899,076

(22) PCT Filed: Jun. 18, 2014
(86) PCT No.: PCT/NL2014/050399

§ 371 Date: Dec. 16, 2015

(30) Foreign Application Priority Data
Jun. 18, 2013 (NL) 2011001

(51) Int. Cl. E02D 7/06; G01N 3/08; E02D 27/12; E02D 27/52; E02D 13/00; E02D 7/14

(52) U.S. Cl. CPC E02D 7/06; E02D 13/00; E02D 7/14; E02D 27/12; E02D 27/52; G01N 3/08

(57) ABSTRACT

The invention relates to a method of installing a foundation element, in particular a (mono)pile, in a ground formation by means of a driver, comprising driving the foundation element into the ground formation by means of blows delivered by the driver to the foundation element, estimating or measuring stress waves that are generated by the blows and reflected from the tip of the foundation element, and, if a reflected stress wave is a tensile stress wave, reducing the blow energy.

### CROSS-REFERENCE TO RELATED APPLICATION

The present application is a national stage filing of International patent application Serial No. PCT/NL2014/050399, filed Jun. 18, 2014, and published as WO 2014/204307 A1 in English.

### BACKGROUND

The discussion below is merely provided for general background information and is not intended to be used as an aid in determining the scope of the claimed subject matter.

Aspects of the invention relate to a method of installing a foundation element, in particular a (mono)pile, in a ground formation, such as a river- or seabed, by means of a driver, e.g. a hydraulic hammer, comprising driving the foundation element into the ground formation by means of blows delivered by the driver to the foundation element. The invention further relates to a driver for installing foundation elements comprising a reciprocal impact weight for delivering blows to the foundation element and an operating system configured to set blow energy and blow count of the weight.

In pile driving, an impulse-like force is applied to the top end of the pile by the impact weight of a hammer. The resulting compressive stress wave propagates downwards, towards to the tip of the pile. If resistance at the tip is high, such that the possible motion of the pile tip is close to zero, it will be reflected as a compressive stress wave. If the tip resistance is very low, such that no force can be exerted from the pile to the soil, the reflection will be a tensile stress wave. In practice, the soil resistance will vary between these extremes.

### SUMMARY

This Summary and the Abstract herein are provided to introduce a selection of concepts in a simplified form that are further described below in the Detailed Description. This Summary and the Abstract are not intended to identify key features or essential features of the claimed subject matter, nor are they intended to be used as an aid in determining the scope of the claimed subject matter. The claimed subject matter is not limited to implementations that solve any or all disadvantages noted in the background.

An aspect of the present invention is to provide an improved method of pile driving in particular to reduce negative effects on fatigue life and/or to reduce sound emission especially when installing a foundation element in an underwater ground formation.

To this end, the method includes estimating or measuring stress waves that are generated by the blows and reflected from the tip of the pile and, if a reflected stress wave is a tensile stress wave, reducing the blow energy.

During driving, the pile is continuously loaded with alternating compressive and tensile stresses. This causes lateral vibrations of the outer surface of the pile in turn resulting in the emission of sound pressure. It also has a negative effect on the fatigue life of the pile, as the fluctuation of compressive and especially tensile stresses accelerate the growth of voids and micro cracks in the material of the pile. With the method the blow energy is reduced or ideally minimized, preferably such that the pile penetration per blow is reduced to a value where the reflected tensile stress is substantially dissipated by the surrounding soil during its upward propagation, towards the top. In quantitative terms, the reflected stress wave, e.g. in terms of strain, is preferably less than 5%, preferably less than 2% of the stress wave resulting from the same blow. Thus, the reflected wave has no or a limited effect on fatigue life and sound emission is further reduced. Other parameters that may serve as an indicator of reflective waves include (but are not limited to) sound or (other) vibrations measured at a predetermined distance from the pile and so-called “quake”, i.e. the elastic component of pile penetration.

In another embodiment, in addition to reducing blow energy, blow count, which conventionally is in a range from 20 to 30 blows per 0.25 meter penetration, is increased, preferably to at least 60, e.g. to at least 70, e.g. to at least 80 blows per 0.25 meter penetration. Thus, if the reduced blow energy results in a lengthening of the time needed to complete pile driving, at least part of this lengthening is compensated. It is preferred that the energy delivered per 0,25 meter penetration is (incrementally) changed, typically reduced, by a total of 30%, preferably 20% or less.

In a particularly efficient embodiment, the strain in the pile is estimated from penetration of the pile resulting from a single blow, e.g. from earlier measurements or from the speed of sound in the pile (˜5200 m/s in a steel pile), duration of the blow, surface area of the cross-section, and the fatigue endurance limit (e.g. 120 MPa).

Another embodiment comprises the step of measuring at least one of strain in the pile, acceleration, velocity or penetration (change in position) of the pile resulting from a blow. In particularly accurate embodiment, both penetration of and the strain in the pile are measured after substantially every blow. In another embodiment, said measuring is performed on a part of the pile that extends above the ground formation.

A further embodiment comprises establishing, e.g. for a specific ground formation or area, at least one blow energy and/or blow count where substantially no tensile wave is measured in driving a first pile and employing that blow energy and/or blow count to drive one or more further piles. Thus, the further pile in principle does not require equipment to carry out such measurements.

The invention also relates to a pile driver comprising a reciprocal impact weight for delivering blows to a foundation element and an operating system configured to set blow energy and blow count of the weight. The operating system is configured to estimate or measure the stress waves that are generated by the blows and reflected from the tip of the pile and, if the reflected stress wave is a tensile stress wave, reduce the blow energy.

In an embodiment, the operating system is configured to reduce the blow energy until substantially no reflected tensile wave is measured.

In another embodiment, the operating system is configured to, in addition to reducing blow energy, increase blow count. It is preferred that the energy delivered per 0.25 meter penetration is (incrementally) changed, typically reduced, by a total of 30%, preferably 20% or less.

### BRIEF DESCRIPTION OF THE DRAWINGS

Aspects of the invention will now be explained in more detail with reference to the Figures, which show a preferred embodiment of the present method and pile driver.

FIG. 1 is a cross-section of a pile driver.

FIGS. 2 to 4 are diagrams of suitable modes of operating of carrying out the invention.

It is noted that the Figures are schematic in nature and that details, which are not necessary for understanding the present invention, may have been omitted.

### DETAILED DESCRIPTION OF THE ILLUSTRATIVE EMBODIMENTS

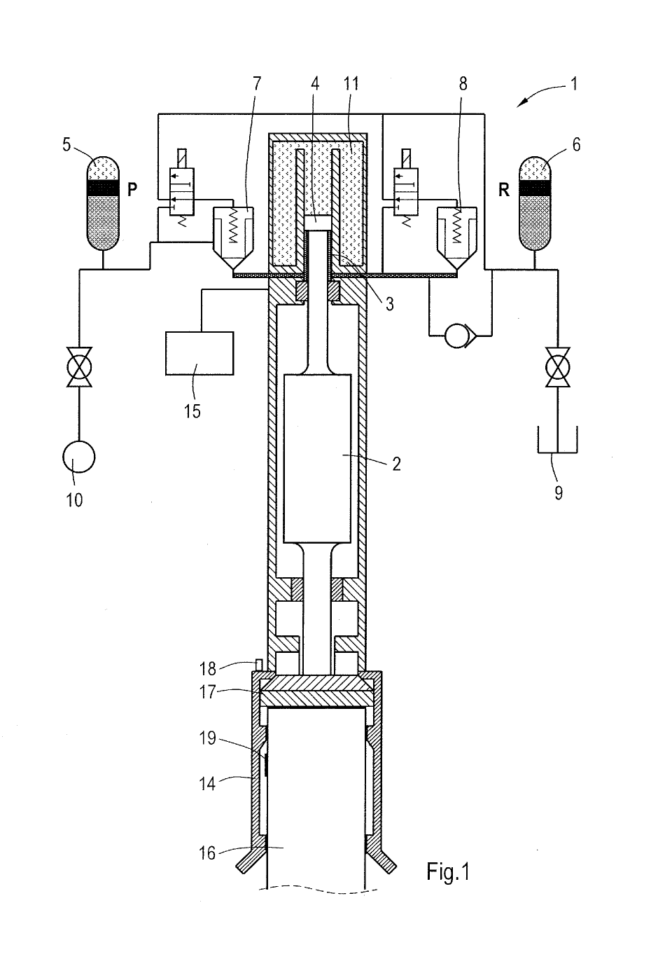

FIG. 1 shows an embodiment of a pile driver 1, which comprises an impact weight 2, a hydraulic cylinder 3, a piston 4 reciprocatingly accommodated in the hydraulic cylinder 3 and connected to or forming an integral part of the impact weight 2, high- and low-pressure accumulators 5, 6, and first and second valves 7, 8 for alternately connecting the cylinder space beneath the piston 4 of the hydraulic cylinder 3 to the high and low-pressure accumulators 5, 6. The system further comprises a tank 9 for a hydraulic medium, such as hydraulic oil, a feed pump 10 for pressurizing the hydraulic medium connected via the high pressure accumulator 5 and the first valve 7 to the hydraulic cylinder 3 and a gas spring or “cap” 11 above the piston 4.

When the first valve 7 is open and the second valve 8 is closed, the high-pressure accumulator 5 communicates with the cylinder space beneath the piston 4 and the piston and impact weight 2 are lifted by the hydraulic medium against the action of the gas spring 11. When the first valve 7 is closed and the second valve 8 is opened, the hydraulic medium flows to the low-pressure accumulator 6 and the tank 9 and the impact weight is accelerated by gravity and the gas spring to deliver a blow to the pile. The pile driver 1 further comprises a sleeve 14 to position the driver 1 onto a pile 16 and an operating system 15 configured to set blow energy and blow count of the weight. Suitable commercially available hammer include IHC Hydrohammer S-class.

The pile driver 1 shown in FIG. 1 is positioned on top of a monopile 16, by means of the sleeve 14 and an anvil 17, and comprises a position sensor 18, e.g. a GPS sensor or an air pressure sensor, mounted on the pile driver 1 and a strain sensor 19, e.g. a strain gauge, attached to the monopile 16.

For a given combination of hammer, anvil and ram, the force exerted by the impact weight 2 on the pile 16 is controlled by the impact speed. he blow energy is calculated from the measured impact speed (just before impact) and the mass of the ram.

The operating system 15 is configured to measure, by means of the sensors 18, 19, the penetration of the pile 16 after each blow and the stress wave that is reflected from the tip of the pile 16.

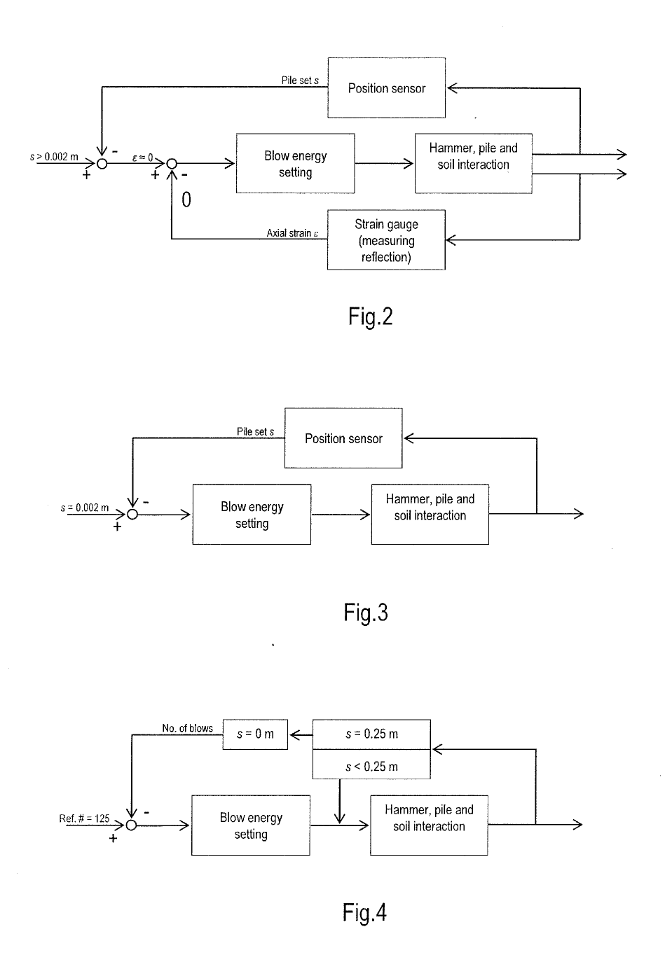

FIG. 2 is diagram of the operating system, which shows that the values measured by the strain gauge and position sensor are used as feedback for the setting of the blow energy. References are e.g. sₚᵢₗₑ>0.0025 m and •_{reflection}•0. After an estimated initial blow energy setting, the blow energy is adjusted to a setting where the pile penetration is sufficient with small reflected stresses.

This is a most effective set-up, as the actual strain and pile set is measured after every blow. The blow energy thus can be adjusted every blow, resulting in a piling process with minimal stress amplitude and lateral pile wall vibrations.

The position sensor is mounted on the hammer and thus can be used for multiple piles. The strain sensor is preferably mounted on the pile and, in that case, can be used only once.

In a further example, shown in FIG. 3, the values measured by the position sensor are compared to an empirically set reference values, without the need for a strain sensor. The reference values provide to the operating system or the operator a maximal pile set per blow, as a higher value could risk reflected tensile stresses. This method is suited e.g. for projects with many piles and consistent soil conditions and where it is sufficient to equip only one or a few piles with strain gauges.

In a further example, shown in FIG. 4, the blow count is compared to an empirically set reference value, e.g. 125 blows per 0.25 m. The blow count is measured by counting the number of blows between two marking lines on the pile. It is standard procedure to record the blow count during pile driving, so this method can be implemented at virtually no extra costs. As with the previous alternative, FIG. 3, this method is suited for projects with many piles and consistent soil conditions. The reference value for the blow count can then be checked and corrected using the data from strain gauges and used for the piles in the vicinity.

The invention is not restricted to the embodiment described above and can be varied in numerous ways within the scope of the claims. For instance, if instrumentation is impossible or unavailable, the reference value for the blow count can be set by making calculations using soil investigations, traditional wave equation piling programs and FEM-calculations.

1. A method of installing a foundation element, in a ground formation by a driver, the method comprising
driving the foundation element into the ground formation by blows delivered by the driver to the foundation element, and
estimating or measuring stress waves that are generated by the blows and reflected from a tip of the foundation element and, if a reflected stress wave is a tensile stress wave, reducing the blow energy.

2. The method according to claim 1, wherein the blow energy is reduced until substantially no reflected tensile wave is measured.

3. The method according to claim 1, wherein, in addition to reducing blow energy, blow count is increased.

4. The method according to claim 1, wherein the energy delivered per 0.25 meter penetration is changed by 30% or less.

5. The method according to claim 1, and further comprising measuring at least one of strain in the foundation element, acceleration, velocity or penetration of the foundation element resulting from a blow.

6. The method according to claim 5, and further comprising measuring penetration of and the strain in the foundation element after substantially every blow.

7. The method according to claim 1, wherein said measuring is performed on a part of the foundation element that extends above the ground formation.

8. The method according to claim 1, and further comprising the step of establishing a blow energy and/or a blow count where substantially no tensile wave is measured in driving a first pile and employing that blow energy and/or blow count to drive one or more further piles.

9. The method according to claim 1, wherein the foundation element is driven into an underwater ground formation.

10. A driver for installing foundation elements in a ground formation, comprising a reciprocally impact weight configured to deliver blows to the foundation element and an operating system configured to set blow energy and blow count of the weight, wherein the operating system is configured to estimate or measure the stress waves that are generated by the blows and reflected from the tip of the foundation element and, if the reflected stress wave is a tensile stress wave, reduce the blow energy.

11. The driver according to claim 10, wherein the operating system is configured to reduce the blow energy until substantially no reflected tensile wave is measured.

12. The driver according to claim 10, wherein the operating system is configured to, in addition to reducing blow energy, increase blow count.

13. The driver according to claim 10, wherein the energy delivered per 0.25 meter penetration is changed by 30% or less.

14. The driver according to claim 10, wherein the operating system is configured to measure at least one of strain in the foundation element, acceleration, velocity or penetration of the foundation element resulting from a blow.

15. The driver according to claim 10, and further comprising a sensor configured to measure penetration of the foundation element and a sensor configured to measure the strain in the foundation element.

16. The driver system of claim 15, wherein the sensor is configured to measure the strain in the foundation element.

17. The driver system of claim 16 wherein the sensor configured to measure the strain in the foundation element is mounted on a part of the pile that extends above the ground formation.

18. The driver system of claim 17 wherein the sensor is configured to measure the strain in the foundation element mounted at or near the top end of the pile.

19. The driver system of claim 3, wherein the blow count is increased to at least 60 blows per 0.25 meter penetration.
